(19) United States
(12) Patent Application Publication
(10) Pub. No.: US 2022/0001911 A1
(43) Pub. Date: Jan. 6, 2022

(54) SWITCH DEVICE

(71) Applicant: KABUSHIKI KAISHA TOKAI RIKA DENKI SEISAKUSHO, Aichi (JP)

(72) Inventor: Takashi UENO, Aichi (JP)

(73) Assignee: KABUSHIKI KAISHA TOKAI RIKA DENKI SEISAKUSHO, Aichi (JP)

(21) Appl. No.: 17/362,026

(22) Filed: Jun. 29, 2021

(30) Foreign Application Priority Data
Jul. 1, 2020 (JP) 2020-114028

(51) Int. Cl. B62D 1/04; B62D 1/08; B62D 1/06

(52) U.S. Cl. CPC B62D 1/046; B62D 1/06; B62D 1/08

(57) ABSTRACT

A switch device includes: a first operation unit disposed in a first region; and at least one of a second operation unit disposed in a second region and a third operation unit disposed in a third region. The first region is a region surrounding a reference point and an upper point. The second region is a region surrounding an outer point, a lower point, and an outer lower point. The third region is a region surrounding an inner upper point and an inner lower point. An outer shape of the first operation unit is smaller than each of an outer shape of the second operation unit and an outer shape of the third operation unit.

This nonprovisional application is based on Japanese Patent Application No. 2020-114028 filed on Jul. 1, 2020 with the Japan Patent Office, the entire contents of which are hereby incorporated by reference.

### BACKGROUND OF THE INVENTION

### Field of the Invention

The present disclosure relates to a switch device.

### Description of the Background Art

Conventionally, a switch device provided in a steering wheel has been known. For example, Japanese Patent Laying-Open No. 2003-306149 discloses a switch device provided at a steering spoke of a steering wheel. This switch device is slidable with respect to the steering spoke.

### SUMMARY OF THE INVENTION

In the case where a push type switch device is disposed in a spoke of a steering wheel, there is a need to reduce the size of the switch device while improving the operability of the switch device.

An object of the present disclosure is to provide a switch device that attains both improved operability and reduced size.

A switch device according to the present disclosure is a switch device provided in a spoke of a steering wheel having the spoke and a rim, the switch device including: a first operation unit disposed in a first region; and at least one of a second operation unit disposed in a second region and a third operation unit disposed in a third region, wherein the first region is a region surrounding a reference point and an upper point, the reference point being located at a setting distance from an intersection portion of the spoke and the rim in a direction toward a center of the rim, the setting distance being set in advance, the upper point being located at a first distance upward from the reference point when viewed in a plan view of the steering wheel, the second region is a region surrounding an outer point, a lower point, and an outer lower point, the outer point being located at a second distance outward from the reference point in a radial direction of the rim when viewed in the plan view, the lower point being located at a third distance downward from the reference point when viewed in the plan view, the outer lower point being located at the third distance downward from the outer point when viewed in the plan view, the third region is a region surrounding an inner upper point and an inner lower point, the inner upper point being located at the first distance upward from an inner point located at a fourth distance inward from the reference point in the radial direction of the rim when viewed in the plan view, the inner lower point being located at the third distance downward from the inner point when viewed in the plan view, and an outer shape of the first operation unit is smaller than each of an outer shape of the second operation unit and an outer shape of the third operation unit.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a cross sectional view schematically showing an arrangement of a switch device according to one embodiment of the present disclosure with respect to a steering wheel.

FIG. 2 is an enlarged view of the switch device shown in FIG. 1.

### DESCRIPTION OF THE PREFERRED EMBODIMENTS

Embodiments of the present disclosure will be described with reference to figures. It should be noted that in the figures stated below, the same or corresponding members are denoted by the same reference characters.

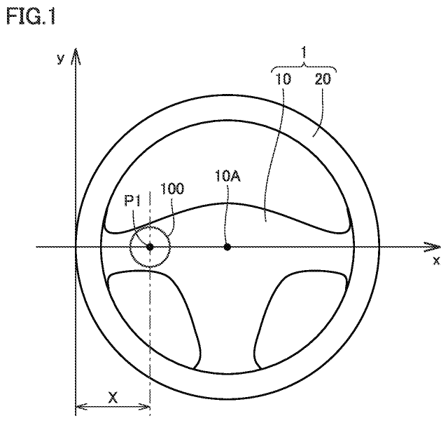

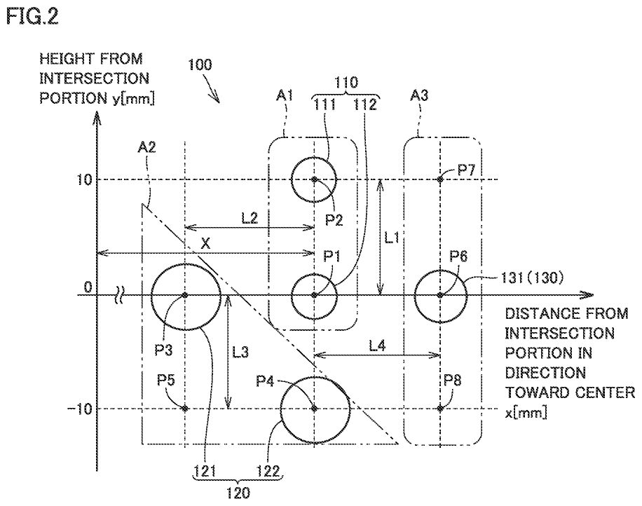

FIG. 1 is a cross sectional view schematically showing an arrangement of a switch device according to one embodiment of the present disclosure with respect to a steering wheel. FIG. 2 is an enlarged view of the switch device shown in FIG. 1.

As shown in FIG. 1, steering wheel 1 includes a spoke 10 and a rim 20.

Spoke 10 is connected to a steering mechanism (not shown) and is rotatable about a rotation axis 10A (see FIG. 1).

Rim 20 is connected to spoke 10. Rim 20 is formed to have an annular shape so as to surround spoke 10.

It should be noted that in FIG. 1, x axis and y axis are virtually shown. The x axis indicates a distance in a direction from an intersection portion of spoke 10 and rim 20 toward the center of rim 20 (rotation axis 10A). The y axis indicates a height from the intersection portion.

Switch device 100 is provided in spoke 10. In the present embodiment, switch device 100 is provided in spoke 10 at a portion located on the left side with respect to rotation axis 10A (a portion that can be operated by the thumb of the left hand when gripping the vicinity of the intersection portion). However, switch device 100 may be provided in spoke 10 at a portion located on the right side with respect to rotation axis 10A. As shown in FIG. 2, switch device 100 includes a first operation unit 110, a second operation unit 120, and a third operation unit 130. Operation units 110 to 130 are push type operation units.

First operation unit 110 is disposed in a first region A1. First region A1 is a region surrounding a reference point P1 and an upper point P2.

Reference point P1 is a point located at a setting distance X from the intersection portion of spoke 10 and rim 20 in the direction toward the center of rim 20, and setting distance X is set in advance. Upper point P2 is a point located at a first distance L1 upward from reference point P1 when viewed in a plan view of steering wheel 1. In the present embodiment, first distance L1 is 10 mm. It should be noted that setting distance Xis preferably set based on the position of the thumb located when the operator grips the vicinity of the intersection portion.

First operation unit 110 has an upper knob 111 and a central knob 112.

Upper knob 111 is disposed at upper point P2. Upper knob 111 is formed to have a circular plate shape. The outer diameter of upper knob 111 is set to about 17 mm.

The center of upper knob 111 is located at upper point P2. However, the center of upper knob 111 may be disposed at a position displaced from upper point P2 as long as upper knob 111 is located in a range including upper point P2. The same applies to central knob 112 as well as an outer knob 121, a lower knob 122, and an inner knob 131, which will be described later.

Central knob 112 is disposed at reference point P1. Central knob 112 is formed to have a circular plate shape. The outer diameter of central knob 112 is set to about 17 mm. It should be noted that the outer shape of central knob 112 is larger than the outer shape of upper knob 111.

Since each of upper knob 111 and central knob 112 can be readily operated by the operator, each of upper knob 111 and central knob 112 is set to have a comparatively small outer shape.

Second operation unit 120 is disposed in a second region A2. Second region A2 is a region surrounding an outer point P3, a lower point P4, and an outer lower point P5.

Outer point P3 is a point located at a second distance L2 outward (left side in FIG. 2) from reference point P1 in the radial direction of rim 20 when viewed in the plan view. Lower point P4 is a point located at a third distance L3 downward from reference point P1 when viewed in the plan view. Outer lower point P5 is a point located at third distance L3 downward from outer point P3 when viewed in the plan view. In the present embodiment, each of second distance L2 and third distance L3 is 10 mm.

The outer shape of second operation unit 120 is larger than the outer shape of first operation unit 110. Second operation unit 120 has outer knob 121 and lower knob 122.

Outer knob 121 is disposed at outer point P3. Outer knob 121 is formed to have a circular plate shape. The outer diameter of outer knob 121 is set to about 20 mm.

Lower knob 122 is disposed at lower point P4. Lower knob 122 is formed to have a circular plate shape. The outer shape of lower knob 122 is set to be the same as the outer shape of outer knob 121.

In order to operate each of outer knob 121 and lower knob 122, it is necessary for the operator to bend a finger or a wrist, so that the outer shape of each of outer knob 121 and lower knob 122 is set to be larger than that of first operation unit 110.

Third operation unit 130 is disposed in third region A3. Third region A3 is a region surrounding an inner upper point P7 and an inner lower point P8.

Inner upper point P7 is a point located at first distance L1 upward from an inner point P6 located at a fourth distance L4 inward (right side in FIG. 2) from reference point P1 in the radial direction of rim 20 when viewed in the plan view. Inner lower point P8 is a point located at third distance L3 downward from inner point P6 when viewed in the plan view. In the present embodiment, fourth distance L4 is 10 mm. That is, in the present embodiment, first distance L1, second distance L2, third distance L3, and fourth distance L4 are equal to one another.

The outer shape of third operation unit 130 is larger than the outer shape of first operation unit 110. The outer shape of third operation unit 130 is smaller than the outer shape of second operation unit 120.

Third operation unit 130 has inner knob 131. Inner knob 131 is disposed at inner point P6. Inner knob 131 is formed to have a circular plate shape. The outer diameter of inner knob 131 is set to, for example, about 18 mm.

The outer shape of inner knob 131 is set to be larger than that of first operation unit 110 and is set to be smaller than that of second operation unit 120 due to the following reasons: as the outer shape of inner knob 131 is larger, the distance from reference point P1 is longer; and as the outer shape of inner knob 131 is smaller, inner knob 131 is less identifiable for the operator.

In the present embodiment described above, when the operator grips the vicinity of the intersection portion of spoke 10 and rim 20, first operation unit 110 is readily operated by the thumb as compared with second operation unit 120 and third operation unit 130, so that the outer shape of first operation unit 110 is set to be smaller than each of the outer shape of second operation unit 120 and the outer shape of third operation unit 130. Therefore, in switch device 100, both improved operability and reduced size are attained.

In the embodiment described above, it has been illustratively described that switch device 100 includes the three operation units, i.e., first operation unit 110, second operation unit 120, and third operation unit 130; however, one of second operation unit 120 and third operation unit 130 may be omitted.

Further, first operation unit 110 may have only one knob, and may be disposed at any position in first region A1. This also applies to second operation unit 120. Third operation unit 130 may have a plurality of knobs, and may be disposed at any position in third region A3.

The illustrative embodiment described above is a specific example of the following implementations.

A switch device according to one implementation is a switch device provided in a spoke of a steering wheel having the spoke and a rim, the switch device including: a first operation unit disposed in a first region; and at least one of a second operation unit disposed in a second region and a third operation unit disposed in a third region, wherein the first region is a region surrounding a reference point and an upper point, the reference point being located at a setting distance from an intersection portion of the spoke and the rim in a direction toward a center of the rim, the setting distance being set in advance, the upper point being located at a first distance upward from the reference point when viewed in a plan view of the steering wheel, the second region is a region surrounding an outer point, a lower point, and an outer lower point, the outer point being located at a second distance outward from the reference point in a radial direction of the rim when viewed in the plan view, the lower point being located at a third distance downward from the reference point when viewed in the plan view, the outer lower point being located at the third distance downward from the outer point when viewed in the plan view, the third region is a region surrounding an inner upper point and an inner lower point, the inner upper point being located at the first distance upward from an inner point located at a fourth distance inward from the reference point in the radial direction of the rim when viewed in the plan view, the inner lower point being located at the third distance downward from the inner point when viewed in the plan view, and an outer shape of the first operation unit is smaller than each of an outer shape of the second operation unit and an outer shape of the third operation unit.

When the operator grips the vicinity of the intersection portion of the spoke and the rim, the first operation unit is readily operated by the thumb as compared with the second operation unit and the third operation unit, so that the outer shape of the first operation unit is set to be smaller than each of the outer shape of the second operation unit and the outer shape of the third operation unit. Therefore, in this switch device, both improved operability and reduced size are attained.

Preferably, the switch device includes both the second operation unit and the third operation unit, wherein the outer shape of the third operation unit is larger than the outer shape of the first operation unit and is smaller than the outer shape of the second operation unit.

Since the operability of the third operation unit is slightly lower than the operability of the first operation unit but is higher than the operability of the second operation unit that requires bending of a finger or a wrist, the operability is maintained and the size is reduced by making the outer shape of the third operation unit larger than the outer shape of the first operation unit and smaller than the outer shape of the second operation unit.

Preferably in this case, the first operation unit includes an upper knob disposed at the upper point, the second operation unit includes an outer knob disposed at the outer point and a lower knob disposed at the lower point, and the third operation unit includes an inner knob disposed at the inner point.

In this implementation, operations in four directions can be performed.

Preferably, an outer shape of the outer knob and an outer shape of the lower knob have the same size.

In this implementation, the operability of both the outer knob and the lower knob is improved.

Preferably, the first operation unit further includes a central knob disposed at the reference point, and an outer shape of the central knob is larger than an outer shape of the upper knob.

Preferably, the first distance, the second distance, the third distance, and the fourth distance are equal to one another.

Although the present invention has been described and illustrated in detail, it is clearly understood that the same is by way of illustration and example only and is not to be taken by way of limitation, the scope of the present invention being interpreted by the terms of the appended claims.

What is claimed is:

1. A switch device provided in a spoke of a steering wheel having the spoke and a rim, the switch device comprising:
a first operation unit disposed in a first region; and
at least one of a second operation unit disposed in a second region and a third operation unit disposed in a third region, wherein
the first region is a region surrounding a reference point and an upper point, the reference point being located at a setting distance from an intersection portion of the spoke and the rim in a direction toward a center of the rim, the setting distance being set in advance, the upper point being located at a first distance upward from the reference point when viewed in a plan view of the steering wheel,
the second region is a region surrounding an outer point, a lower point, and an outer lower point, the outer point being located at a second distance outward from the reference point in a radial direction of the rim when viewed in the plan view, the lower point being located at a third distance downward from the reference point when viewed in the plan view, the outer lower point being located at the third distance downward from the outer point when viewed in the plan view,
the third region is a region surrounding an inner upper point and an inner lower point, the inner upper point being located at the first distance upward from an inner point located at a fourth distance inward from the reference point in the radial direction of the rim when viewed in the plan view, the inner lower point being located at the third distance downward from the inner point when viewed in the plan view, and
an outer shape of the first operation unit is smaller than each of an outer shape of the second operation unit and an outer shape of the third operation unit.

2. The switch device according to claim 1, comprising both the second operation unit and the third operation unit, wherein the outer shape of the third operation unit is larger than the outer shape of the first operation unit and is smaller than the outer shape of the second operation unit.

3. The switch device according to claim 2, wherein
the first operation unit includes an upper knob disposed at the upper point,
the second operation unit includes an outer knob disposed at the outer point and a lower knob disposed at the lower point, and
the third operation unit includes an inner knob disposed at the inner point.

4. The switch device according to claim 3, wherein an outer shape of the outer knob and an outer shape of the lower knob have the same size.

5. The switch device according to claim 3, wherein
the first operation unit further includes a central knob disposed at the reference point, and
an outer shape of the central knob is larger than an outer shape of the upper knob.

6. The switch device according to claim 1, wherein the first distance, the second distance, the third distance, and the fourth distance are equal to one another.
